(19) United States
(12) Patent Application Publication
(10) Pub. No.: US 2025/0172286 A1
(43) Pub. Date: May 29, 2025

(54) INDUSTRIAL BOILER MONITORING METHOD FOR ARTIFICIAL INTELLIGENCE-BASED EXHAUST GAS ANALYSIS AND FAULT DIAGNOSIS

(71) Applicant: DAELIM ROYAL EnP CO., LTD., Gyeongsangbuk-do (KR)

(72) Inventors: Ju Hwa JUNG, Daegu (KR); Jong Hun KIM, Daegu (KR); Chi Kwan KIM, Daegu (KR)

(21) Appl. No.: 18/780,354

(22) Filed: Jul. 22, 2024

(30) Foreign Application Priority Data
Nov. 27, 2023 (KR) 10-2023-0166976

(51) Int. Cl. F22B 35/18

(52) U.S. Cl. CPC F22B 35/18

(57) ABSTRACT

The present invention relates to an industrial boiler monitoring system for artificial intelligence-based exhaust gas analysis and fault diagnosis, which can construct a customized artificial intelligence-based learning model for diagnosing the concentration of exhaust gas to individual boilers of a customer and faults of various components, and diagnose the concentration of exhaust gas and faults of various components in real-time through the constructed learning model.

### CROSS-REFERENCE TO RELATED APPLICATION

This application claims priority under 35 U.S.C § 119 to Korean Patent Application No. 10-2023-0166976 filed in the Korean Intellectual Property Office on Nov. 27, 2023, the entire contents of which are hereby incorporated by reference.

### BACKGROUND OF THE INVENTION

### Field of the Invention

The present invention relates to an industrial boiler monitoring system for artificial intelligence-based exhaust gas analysis and fault diagnosis, which can construct a customized artificial intelligence-based learning model for diagnosing the concentration of exhaust gas to individual boilers of a customer and faults of various components, and diagnose the concentration of exhaust gas and faults of various components in real-time through the constructed learning model.

### Background Art

Industrial boilers are the largest energy-consuming equipment, which occupies 30% of the total energy consumption and occupies 47% of the industrial energy consumption in Korea, so it is essential to develop technologies for greenhouse gas reduction and energy saving effects. Consequently, there is significant interest in reliable and cost-effective real-time exhaust gas and fault diagnosis analysis devices exclusively for industrial boilers.

If the emission concentration of substances is identified in real-time, in case of a problem occurrence during the operation of the boilers, the exhaust gas and fault diagnosis analysis devices exclusively for industrial boilers can immediately recognize the problem, and proactively respond to decrease in efficiency and atmospheric pollution by setting new air-fuel ratios.

In Korea, the government is gradually expanding the installation of tele-monitoring systems (TMSs) relative to combustion equipment at large industrial sites to suppress the emission of fine dust and atmospheric pollutants.

As of 2018, there are 56,151 registered combustion facilities in Korea, but only 5,510 combustion facilities have TMS installed facilities, so the number of combustion facilities equipped with the tele-monitoring systems is desperately insufficient.

Since the law targets large-scale industrial sites and the TMS is a high-cost device costing several hundred million won, it is difficult for small enterprises to afford to buy and operate the TMS.

Accordingly, the majority of industrial boilers operate in accordance with the air-fuel ratio set by manufacturers at the time of a test drive, but do not find the generation amount and the emission amount of air pollutants from exhaust gas before failure of the boilers.

### PATENT LITERATURE

### Patent Documents

Patent Document 1: Korean Patent No. 10-2078242 (Feb. 11, 2020)

### SUMMARY OF THE INVENTION

Accordingly, the present invention has been made to solve the above-mentioned problems occurring in the prior arts, and it is an objective of the present invention to provide an industrial boiler monitoring system for artificial intelligence-based exhaust gas analysis and fault diagnosis, which can construct a customized artificial intelligence-based learning model for diagnosing the concentration of exhaust gas to individual boilers of a customer and faults of various components, and diagnose the concentration of exhaust gas and faults of various components in real-time through the constructed learning model.

It is another objective of the present invention to manufacture a real-time exhaust gas concentration measurement device at a lower cost than the purchase price of the typical tele-monitoring system (TMS) through construction of a virtual sensor module for predicting the exhaust gas concentration.

It is a further objective of the present invention is to construct a fault diagnosis module for diagnosing the faults of essential components of the boiler in real-time, thereby rapidly coping with the faults through alarms, and identifying anomalies of components and proactively taking measures through real-time exhaust gas concentration when incomplete combustion occurs.

To accomplish the above object, according to the present invention, there is provided an industrial boiler monitoring system for artificial intelligence-based exhaust gas analysis and fault diagnosis including: (a) a step (S100) in which a service provider operates individual boilers of a customer for a predetermined period after test-driving of the individual boilers to acquire input and output data concerning essential components and input and output data concerning measured exhaust gas concentrations; (b) a step (S200) of creating big data for the individual boilers of the customer based on the acquired data; (c) a step (S300) of constructing a virtual sensor module for measuring the concentration of virtual exhaust gas and a fault diagnosis module for diagnosing faults of components through machine learning techniques based on the big data; (d) a step (S400) of installing the virtual sensor module and the fault diagnosis module constructed in step (c) on the individual boilers, and transmitting operational data generated during the operation of the individual boilers to a management server; (e) a step (S500) of calculating the exhaust gas concentration using the operational data by the virtual sensor module in the individual boilers, and calculating the failure potential of components by the fault diagnosis module; and (f) a step (S600) in which the individual boilers transmit and store the calculated concentrations of exhaust gas and the results of fault diagnosis of the components to the management server via application and web, and in which the service provider monitors the combustion state of the individual boilers in real-time and issues an alarm at the time of abnormal operation of the boilers caused by incomplete combustion or component failures.

According to the present invention, the fault diagnosis module is constructed by a principal component analysis (PCA) model using the machine learning technique.

According to the present invention, the fault diagnosis by the fault diagnosis module is conducted by the reconstruction-based contribution (RBC) technique based on error instruction correction, which is based on real-time measurements of temperature, pressure, and flow rates from the sensors installed on the components, and predicted values learned through the PCA model.

According to the present invention, the fault diagnosis by the fault diagnosis module includes: (e-1) a step (S510) of detecting sensor failures through the reconstruction-based contribution (RBC); (e-2) a step (S520) of identifying failed sensors after detecting sensor failures; (e-3) a step (S530) of performing error instruction correction relative to the failed sensors; and (e-4) a step (S540) of detecting sensor failures after the error instruction correction, wherein after the error instruction correction, during detection of sensor failures, when failed sensors are detected, an alarm is issued by step (f) (S600).

According to the present invention, the virtual sensor module is constructed by a regression model utilizing the statistical-based partial least squares (PLS) and the auto-encoder neural network among the machine learning techniques.

According to the present invention, the virtual sensor module predicts concentrations of oxygen (O₂), sulfur oxides (SOx), nitrogen oxides (NOx), and carbon monoxide (CO) using the operational data of the individual boilers.

According to the present invention, the industrial boiler monitoring system for artificial intelligence-based exhaust gas analysis and fault diagnosis can construct a customized artificial intelligence-based learning model for diagnosing the concentration of exhaust gas to individual boilers of a customer and faults of various components, and diagnose the concentration of exhaust gas and faults of various components in real-time through the constructed learning model.

Moreover, the industrial boiler monitoring system for artificial intelligence-based exhaust gas analysis and fault diagnosis can be produced at a lower cost than the purchase price of the typical tele-monitoring system (TMS) through construction of the virtual sensor module for predicting the exhaust gas concentration, thereby securing economic feasibility.

Furthermore, the industrial boiler monitoring system for artificial intelligence-based exhaust gas analysis and fault diagnosis can diagnose the faults of essential components of the boiler in real-time through construction of the fault diagnosis module, thereby rapidly coping with the faults through alarms, and identifying anomalies of components and proactively taking measures through real-time exhaust gas concentration when incomplete combustion occurs.

Additionally, the industrial boiler monitoring system for artificial intelligence-based exhaust gas analysis and fault diagnosis can measure the concentrations of oxygen and carbon monoxide in exhaust gas in real-time, thereby actively preventing combustion deficiencies due to excess air or misfire, and achieving optimization of the combustion-to-air ratio of the boiler.

In addition, the industrial boiler monitoring system for artificial intelligence-based exhaust gas analysis and fault diagnosis can early detect excess air due to abnormal oxygen levels, thereby reducing fuel costs, and maximizing the effects of preventive maintenance by proactively identifying the faults of components due to an abnormal air-fuel ratio of the boiler.

### BRIEF DESCRIPTION OF THE DRAWINGS

FIG. 1 is a flowchart representing an industrial boiler monitoring system for artificial intelligence-based exhaust gas analysis and fault diagnosis according to the present invention.

FIG. 2 is a flowchart showing a fault diagnosis process in the industrial boiler monitoring system according to the present invention.

FIG. 3 is a conceptual diagram illustrating the industrial boiler monitoring system according to the present invention.

FIG. 4 is a process diagram and a sensor location map of a target boiler used for the accuracy validation and performance certification of an analysis model according to the present invention.

FIG. 5 is a diagram showing the monitoring results obtained by actually applying the monitoring system according to the present invention.

### DETAILED DESCRIPTION OF THE PREFERRED EMBODIMENT

Hereinafter, to describe the objectives achieved by the operation and implementation of the present invention, preferred embodiments of the present invention will be illustrated, and with reference to the embodiments, the present invention will be described.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

In the description, details of well-known features and techniques may be omitted to avoid unnecessarily obscuring the presented embodiments.

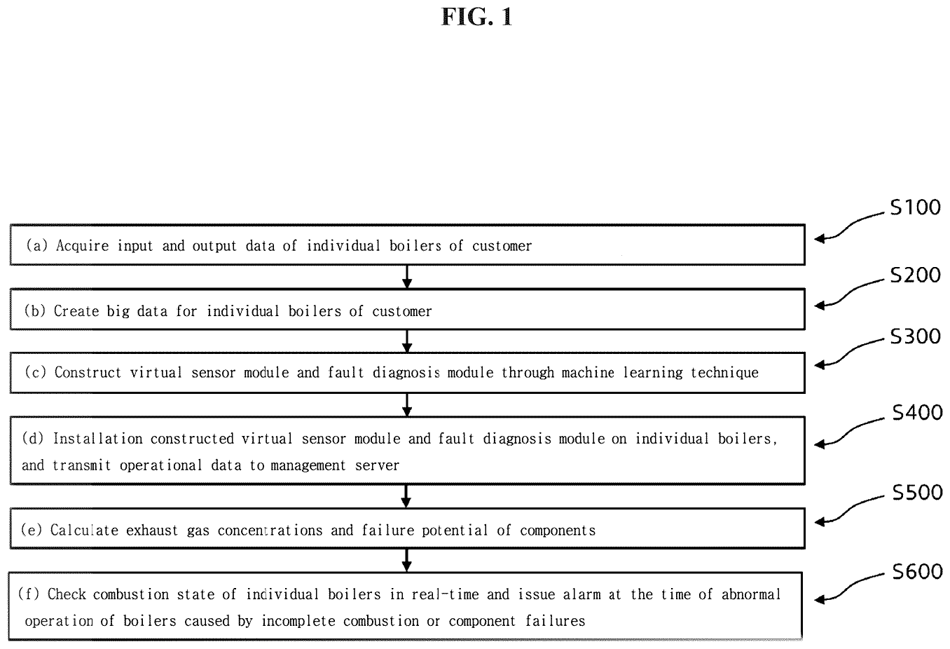

As illustrated in FIGS. 1 to 3, an industrial boiler monitoring system for artificial intelligence-based exhaust gas analysis and fault diagnosis according to the present invention includes: (a) a data acquisition step (S100) for individual boilers 10 of a customer; (b) a big data construction step (S200); (c) a step (S300) for constructing a virtual sensor module 40 and a fault diagnosis module 50 utilizing machine learning techniques; (d) a step (S400) for installing the virtual sensor module 40 and the fault diagnosis module 50 constructed on the individual boilers 10 and transmitting operation data to a management server 30; (e) a calculation step (S500) of exhaust gas concentration and potential faults of components; and (f) a step (S600) of checking the combustion state of the individual boilers 10 in real-time, and generating an alarm when the boiler operates abnormally due to incomplete combustion or faults of components.

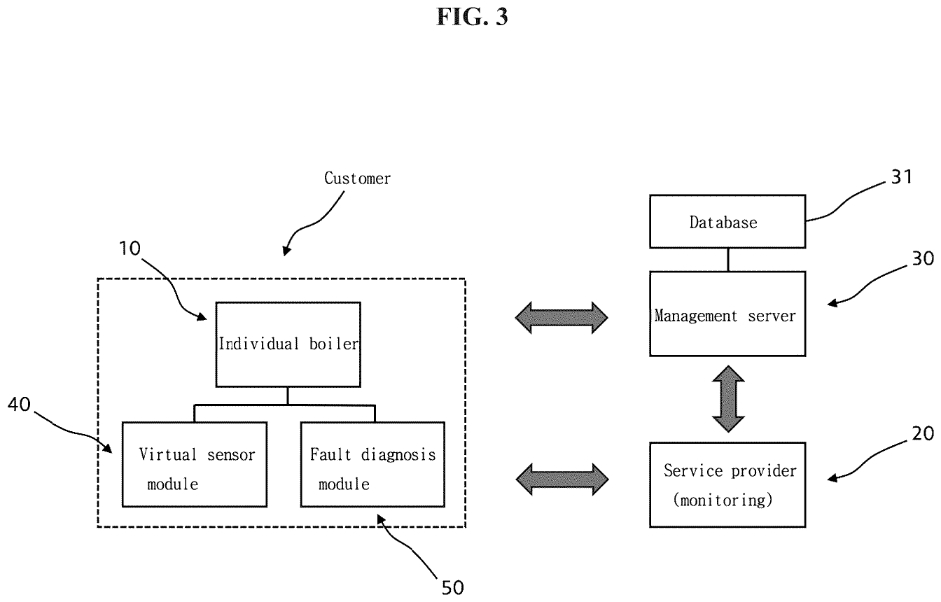

First, as illustrated in FIGS. 1 and 3, step (a) (S100) according to the present invention involves a process in which the service provider 20 operates the individual boilers 10 of the customer for a predetermined period after test-driving of the individual boilers 10 to acquire input and output data concerning essential components of the boiler and input and output data concerning measured exhaust gas concentrations.

Specifically, in step (a), to construct a customized analysis model for each customer, the individual boilers 10 of the customer are operated for approximately two to three weeks, and the input and output data of the operation are collected and acquired. The acquired data is utilized as basic data for constructing the virtual sensor module 40 and the fault diagnosis module 50 which will be described later.

Next, as illustrated in FIGS. 1 and 3, step (b) (S200) according to the present invention is a process of creating big data for the individual boilers 10 of the customer based on the data acquired in step (a) (S100).

That is, in step (b) (S200), the data acquired from the individual boilers 10 of the customer is stored by each customer in a database 31 of the management server 30 to create big data, and the virtual sensor module 40 and the fault diagnosis module 50 are constructed through machine learning techniques utilizing the big data.

As illustrated in FIGS. 1 and 3, step (c) (S300) according to the present invention is a process of customizing the construction of the virtual sensor module 40 for measuring the concentration of virtual exhaust gas and the fault diagnosis module 50 for diagnosing faults of components through the machine learning techniques based on the big data prepared for each customer.

First, the virtual sensor module 40 can be constructed by a regression model through statistical-based partial least squares (PLS) and auto-encoder neural networks among the machine learning techniques.

In this case, due to the high collinearity among variables in factory equipment data like boilers, it is preferable to utilize the PLS which is the multivariate statistical-based machine learning technique showing excellent performance in extracting latent variables to reduce the dimensionality of the data and interpreting data characteristics. Additionally, it is also preferable to utilize the auto-encoder neural network technique as a secondary method.

The virtual sensor module 40 can measure the concentrations of oxygen (O₂), sulfur oxides (SOx), nitrogen oxides (NOx), and carbon monoxide (CO) in real-time. To measure the concentrations, real-time operational data measured from the individual boilers 10 is utilized, and for this purpose, various sensors for data collection can be deployed in each individual boiler 10.

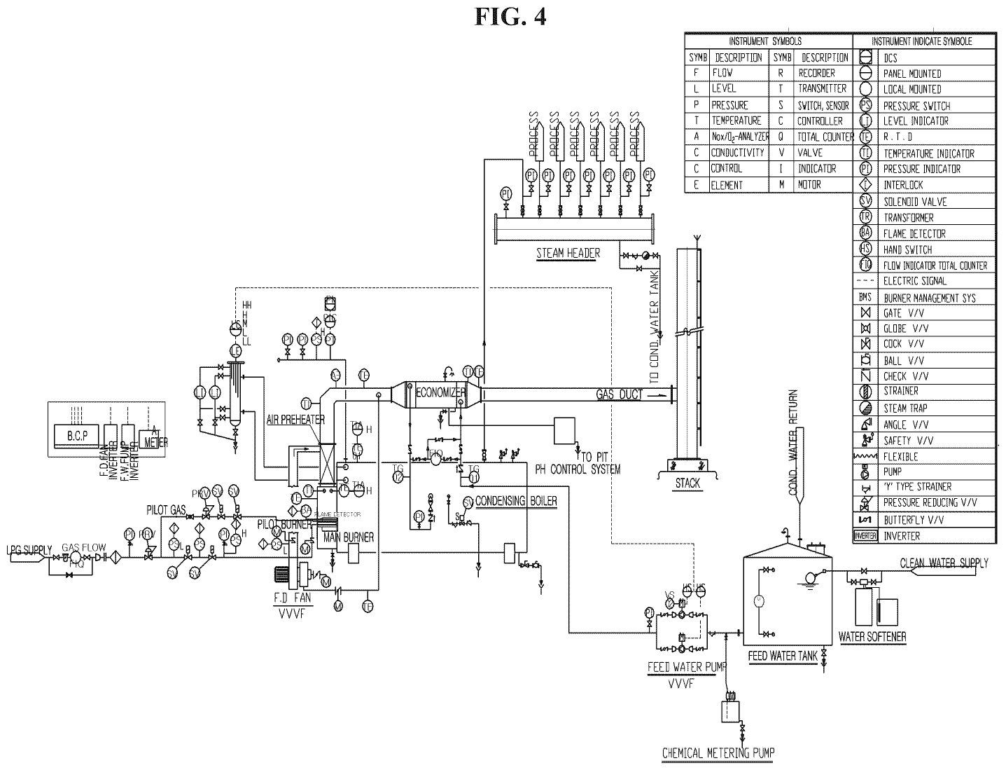

FIG. 4 illustrates a process diagram of the boiler and a sensor position diagram which were used for the accuracy verification and performance certification of the virtual sensor module 40.

Next, the fault diagnosis module 50 was constructed by a principal component analysis (PCA) model using the machine learning technique.

In addition, the fault diagnosis is conducted using the reconstruction-based contribution (RBC) technique based on error instruction correction, which is based on real-time measurements of temperature, pressure, and flow rates from the sensors installed on the essential components of the individual boilers 10, and predicted values learned through the PCA model.

The fault diagnosis by the fault diagnosis module 50 includes sensor failure detection, failed sensor identification, and error instruction correction.

Even if the fault diagnosis module 50 is accurate, the sensor failure detection may have errors in predicted values when the sensors instruct input variables such as temperature, pressure, and flow in errors. Therefore, it is essential for the fault diagnosis module 50 to identify failures of the sensors and provide accurate predicted values instead of measured values in case of failure.

Accordingly, the reconstruction-based contribution (RBC) technique based on error instruction correction is used to determine if the sensors are functioning normally.

To identify the failure of the sensors, assuming that all sensors are faulty, the error instruction magnitudes of each sensor are sequentially calculated using the PCA model, and then, failed sensors are identified through the error instruction magnitudes.

As described above, the sensor failure diagnosis by the fault diagnosis module 50 according to the present invention is performed through the processes including sensor failure detection, failed sensor identification, and error instruction correction. The specific processes will be described later.

As illustrated in FIGS. 1 and 3, step (d) (S400) according to the present invention is a process of installing the constructed virtual sensor module 40 and the constructed fault diagnosis module 50 on the individual boilers 10 and transmitting operational data generated during the operation of the individual boilers 10 to the management server 30.

In step (d) (S400), when the service provider constructs the virtual sensor module 40 and the fault diagnosis module 50 and distributes the constructed virtual sensor module 40 and the constructed fault diagnosis module 50 to the customer both online and offline, the customer installs the virtual sensor module 40 and the fault diagnosis module 50 on the individual boilers 10 to be integrated with the boilers.

Furthermore, the customer transmits the operational data generated through the operation of the individual boilers 10 to the management server 30 via wired or wireless communication networks or internet networks to, and then, the management server 30 stores the operational data in the database 31 in real-time to create big data.

As illustrated in FIGS. 1 to 3, step (e) (S500) according to the present invention is a process of calculating the exhaust gas concentration using the operational data by the virtual sensor module 40 in the individual boilers 10, and calculating the failure potential of components using the fault diagnosis module 50.

That is, in step (e) (S500), the concentrations of carbon dioxide (CO₂), sulfur oxides (SOx), nitrogen oxides (NOx), and carbon monoxide (CO) are measured in real-time by the virtual sensor module 40.

Especially, since the optimal combustion of boilers is crucially dependent on the ratio of combustion to air, real-time measurement of the concentrations of O₂ and CO in exhaust gases enables proactive measures against the poor combustion due to excess air or misfire. Moreover, the real-time measurement can lead to early detection of excess air due to abnormal O₂ concentrations, thereby reducing fuel costs. Additionally, the real-time measurement can lead to proactive identification of component faults caused by abnormal air-fuel ratios of the boilers, thereby maximizing the effects of preventive maintenance.

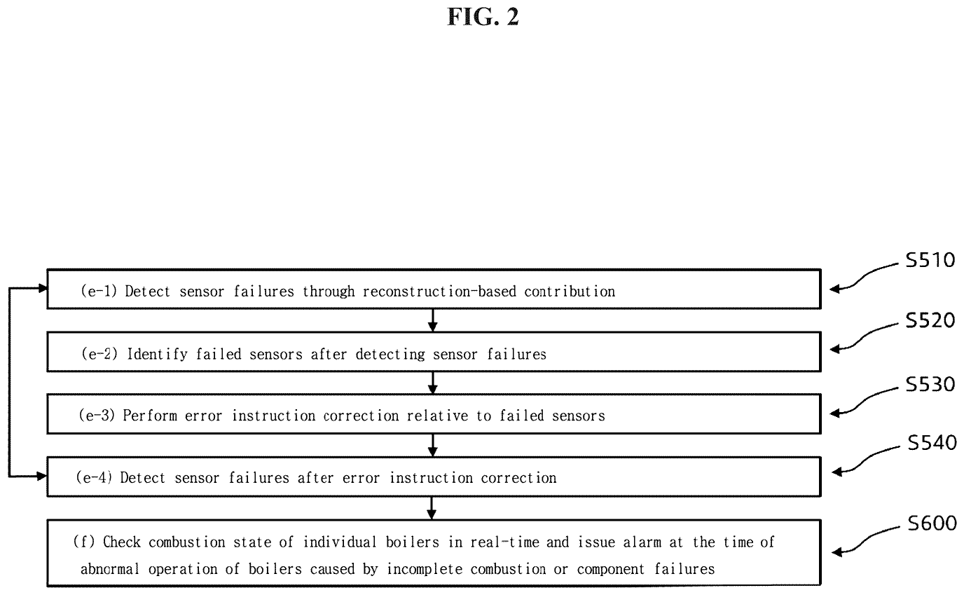

As illustrated in FIG. 2, the fault diagnosis module 50 diagnoses sensor failures of the essential components, and the process includes: (e-1) a step (S510) of detecting sensor failures through the reconstruction-based contribution (RBC); (e-2) a step (S520) of identifying failed sensors after detecting sensor failures; (e-3) a step (S530) of performing error instruction correction relative to the failed sensors; and (e-4) a step (S540) of detecting sensor failures after the error instruction correction. In this case, after the error instruction correction, during detection of sensor failures, when failed sensors are detected, in the following step (f) (S600), an alarm is issued to alert the customer or an on-site manager.

The specific computations in each process for the fault diagnosis can be conducted as previously described.

If sensor failures are not detected in the sensor failure detection step, all sensor values are considered normal.

Conversely, if sensor failures are detected, the failed sensors are identified using the reconstruction-based contribution (RBC) technique based on error instruction correction, error instruction correction is performed relative to the failed sensors, and then, if the sensor failure is resolved when sensor failure is determined, it is diagnosed as a single sensor failure. Additionally, after the error instruction correction, if the sensor failure is not resolved when sensor failure is determined, it is diagnosed as failures of multiple sensors or a process abnormality.

When diagnosed as sensor failures, the service provider transmits an alarm to the customer or the on-site manager through an app or web via real-time monitoring, enabling immediate action.

As illustrated in FIGS. 1 and 3, step (f) (S600) according to the present invention is a process in which the individual boilers 10 transmit and store the calculated concentrations of exhaust gas and the results of fault diagnosis of the components to the management server 30 via application and web, and in which the service provider 20 monitors the combustion state of the individual boilers 10 in real-time and issues an alarm at the time of abnormal operation of the boilers caused by incomplete combustion or component failures.

That is, in step (f) (S600), the service provider monitors the exhaust gas concentrations and the results of fault diagnosis of components calculated from the individual boilers 10 installed on sites, namely, at various customer sites, in real-time, and then, transmits the monitoring results to the on-site manager through the application installed on the manager terminal, or issues an alarm using communication networks or internet networks.

It is preferable that the customer or the on-site manager who received the alarm must promptly take actions, such as halting the operation of the boiler or replacing or repairing the faulty components, to prevent reduction in efficiency of the boiler.

The monitoring system according to the present invention includes individual boilers 10 of the customer, and a virtual sensor module 40 and a fault diagnosis module 50 mounted on each individual boiler 10. Additionally, the individual customer boilers 10 of the customer, the virtual sensor module 40, and the fault diagnosis module 50 are configured to transmit and receive data with a management server 30. The service provider 20 monitors the exhaust gas concentrations and fault diagnosis results of the individual boilers 10 in real-time via wired or wireless communication networks or internet networks, and transmits an alarm to the customer or the on-site manager in real-time in cases of abnormal exhaust gas concentrations or sensor failures.

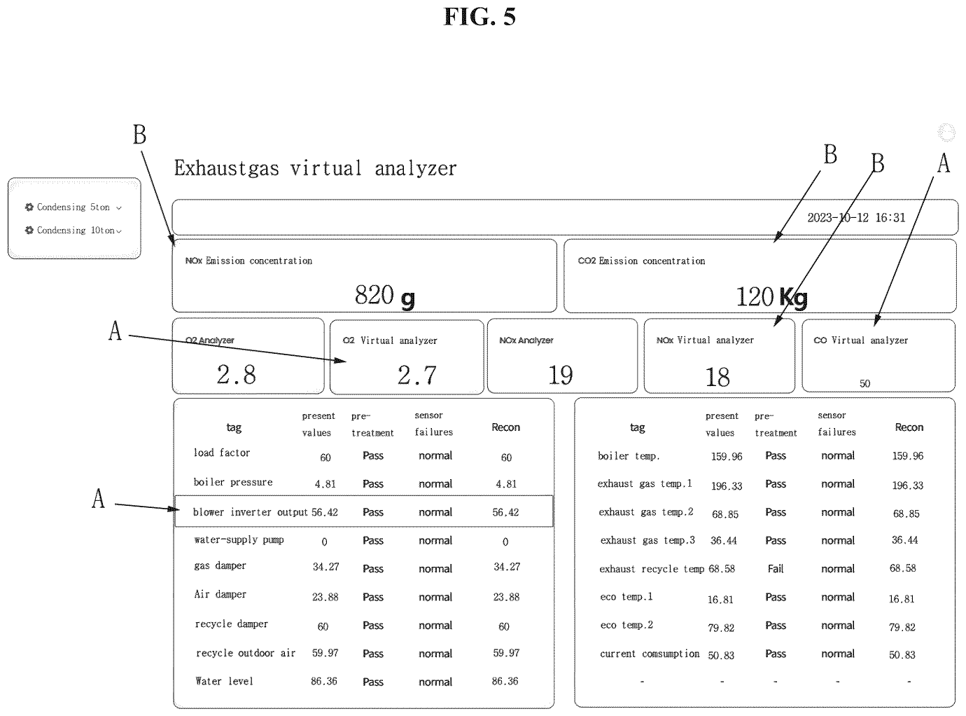

FIG. 5 illustrates the monitoring results by the service provider.

In FIG. 5, The first window A displays an example where if incomplete combustion occurs due to a failure of the blower inverter, the service provider checks incomplete combustion through O₂ and CO values of the virtual exhaust gas, and the fault diagnosis module identifies whether there is a fault in the blower inverter.

In FIG. 5, The second window B displays the emission concentrations of nitrogen oxides (NOx) and carbon dioxide (CO₂) in real-time through AI-based exhaust gas analysis, and shows the calculation of emission quantities according to a formula.

As described above, while the present invention has been described with reference to the illustrated embodiments, it should be understood that the embodiments are merely exemplary, and that those skilled in the art may make various modifications and equivalents.

Therefore, the true scope of the technical protection of the present invention should be defined by the technical spirit of the appended claims.

What is claimed is:

1. An industrial boiler monitoring system for artificial intelligence-based exhaust gas analysis and fault diagnosis comprising:
(a) a step (S100) in which a service provider operates individual boilers of a customer for a predetermined period after test-driving of the individual boilers to acquire input and output data concerning essential components and input and output data concerning measured exhaust gas concentrations;
(b) a step (S200) of creating big data for the individual boilers of the customer based on the acquired data;
(c) a step (S300) of constructing a virtual sensor module for measuring the concentration of virtual exhaust gas and a fault diagnosis module for diagnosing faults of components through machine learning techniques based on the big data;
(d) a step (S400) of installing the virtual sensor module and the fault diagnosis module constructed in step (c) on the individual boilers, and transmitting operational data generated during the operation of the individual boilers to a management server;
(e) a step (S500) of calculating the exhaust gas concentration using the operational data by the virtual sensor module in the individual boilers, and calculating the failure potential of components by the fault diagnosis module; and
(f) a step (S600) in which the individual boilers transmit and store the calculated concentrations of exhaust gas and the results of fault diagnosis of the components to the management server via application and web, and in which the service provider monitors the combustion state of the individual boilers in real-time and issues an alarm at the time of abnormal operation of the boilers caused by incomplete combustion or component failures.

2. The industrial boiler monitoring system according to claim 1, wherein the fault diagnosis module is constructed by a principal component analysis (PCA) model using the machine learning technique.

3. The industrial boiler monitoring system according to claim 2, wherein the fault diagnosis by the fault diagnosis module is conducted by the reconstruction-based contribution (RBC) technique based on error instruction correction, which is based on real-time measurements of temperature, pressure, and flow rates from the sensors installed on the components, and predicted values learned through the PCA model.

4. The industrial boiler monitoring system according to claim 3, wherein the fault diagnosis by the fault diagnosis module includes:
(e-1) a step (S510) of detecting sensor failures through the reconstruction-based contribution (RBC);
(e-2) a step (S520) of identifying failed sensors after detecting sensor failures;
(e-3) a step (S530) of performing error instruction correction relative to the failed sensors; and
(e-4) a step (S540) of detecting sensor failures after the error instruction correction, wherein after the error instruction correction, during detection of sensor failures, when failed sensors are detected, an alarm is issued by step (f) (S600).

5. The industrial boiler monitoring system according to claim 1, wherein the virtual sensor module is constructed by a regression model utilizing the statistical-based partial least squares (PLS) and the auto-encoder neural network among the machine learning techniques.

6. The industrial boiler monitoring system according to claim 5, wherein the virtual sensor module predicts concentrations of oxygen (O₂), sulfur oxides (SOx), nitrogen oxides (NOx), and carbon monoxide (CO) using the operational data of the individual boilers.
